(19) United States
(12) Patent Application Publication
(10) Pub. No.: US 2021/0120824 A1
(43) Pub. Date: Apr. 29, 2021

(54) METHODS OF ATTRACTING MALE CONOPOMORPHA CRAMERELLA

(71) Applicants: The United States of America, as represented by the Secretary of Agriculture, Washington, DC (US); Mars, Inc., McLean, VA (US)

(72) Inventors: Paul E. Kendra, Plantation, FL (US); Jerome Niogret, Miami, FL (US); Nancy Epsky, Cutler Bay, FL (US); Nurhayat Tabanca, Cutler Bay, FL (US)

(21) Appl. No.: 17/080,975

(22) Filed: Oct. 27, 2020

Related U.S. Application Data
(60) Provisional application No. 62/926,641, filed on Oct. 28, 2019.

(51) Int. Cl. A01N 65/08; A01M 1/02

(52) U.S. Cl. CPC A01N 65/08; A01M 1/02

(57) ABSTRACT

Methods of attracting male Conopomorpha cramerella involving treating an object or area with a composition comprising a male Conopomorpha cramerella attracting effective amount of an extract of Litchi sinensis, and optionally a carrier; wherein the composition is in a trap.

### REFERENCE TO RELATED APPLICATION

This application claims the benefit of U.S. Provisional Application No. 62/926,641 filed 28 Oct. 2019, which is incorporated herein by reference in its entirety.

### BACKGROUND OF THE INVENTION

Disclosed herein are methods of attracting male Conopomorpha cramerella involving treating an object or area with a composition comprising a male Conopomorpha cramerella attracting effective amount of an extract of Litchi sinensis, and optionally a carrier; wherein the composition is in a trap. These methods could be used to attract, survey, monitor and/or control this and related pest insects.

The cocoa pod borer (CPB) Conopomorpha cramerella (Snellen) (Lepidoptera: Gracillariidae) is a moth species endemic to Southeast Asia. It is thought that CPB initially utilized native host trees of the Sapindale Order, including rambutan, Fiji longan, and langsat, before becoming a pest of economic importance for the cocoa industry in Indonesia, the Philippines, Malaysia, and Papua New Guinea. The pest's devastating impact on cocoa farms is responsible in large part for the drastic decline in Malaysian cocoa production, as well as in other areas of Southeast Asia. It is estimated to be directly and indirectly responsible for about $500M in annual losses in Indonesia alone (International Cocoa Organization (ICCO), Pest and diseases. Cocoa pod borer (C. cramerella), 2015).

Several control measures have been implemented over the past decades to combat CPB infestation with limited success. Biological control measures were found to have minimal impact; parasitoids and entomopathogens did not provide enough efficacy or were not economically viable (Von Arx, M., et al., Journal of Chemical Ecology, 38: 222-225 (2012); Rosmana, A., et al., Agritrop, 28: 161-168 (2009); Lim, G. T., and K. Y. Pan, Observations on the sexual activity and egg production of cocoa pod borer Conopomorpha cramerella (Snellen) in the laboratory, 1986 Annual Research Report, Department of Agriculture, Kota Kinabalu, Sabah), while predation and disturbance using black ants did not demonstrate promising results (See, Y. A., and K. C. Koo, Bulletin of Entomological Research, 86: 467-474 (1996)). Preventing CPB oviposition on cocoa pods can be achieved successfully by covering the fruits with plastic bags, or sleeves, but this method is considered by many farmers as too labor intensive (Vanialingam, T., et al., Proc. Eight. Int. Cocoa Res. Conf., pp. 345-351 (1981); Yeudeowei, A., Review of cocoa pests in Indonesia and the Philippines: Developing bulk cocoa in Indonesia, Report on a visit 7 Feb.-14 Mar. 1980, page 73). A complete and synchronic harvesting of mature pods can significantly reduce pest populations, but only temporarily due to reintroductions from neighboring farms or from alternative hosts (Lim, G. T., 1992, Biology, ecology and control of cocoa pod borer Conopomorpha cramerella (Snellen), pp. 85-100, IN: P. J. Keane and C. A. J. Putter (Eds.), Cocoa Pest and Disease Management in Southeast Asia and Australia, FAO Plant Production and Protection Paper No. 122, FAO, Rome, Italy). At present, the most effective method for control of CPB is still the use of pesticides, but the cost/efficiency ratio remains poor due to the pest's life cycle (i.e., the larval stages are protected within the pod and not exposed to topical insecticides) (Wood B. J., et al., Trop. Pest Manag., 38: 271-278 (1992); Beevor, P. S., et al., Crop Protect., 12: 134-140 (1993); The, C.-L., et al., Crop Protection, 25: 712-717 (2006)). The Malaysian Cocoa Board recommendations for 22 annual insecticide applications is not sustainable from an environmental and financial perspective. However, a reduction of CPB infestation with losses under 10% can be achieved in Sulawesi with 10 (2×5) annual applications of lower toxicity pesticides (e.g., chlorantraniliprol, or synthetic pyrethroids) (Smilja Lambert, pers. comm.). More sustainable control methods for CPB should be developed due to increasing concerns about pesticide residues in chocolate. Meanwhile, pesticide applications directly related to the phenology of the crop and the CPB population density should be prioritized over regular and systematic applications without knowledge of the pest abundance in the field.

The CPB pheromone composition has been identified, and a blend of 4 components ((E,Z,Z)- and (E,E,Z)-4,6,10-hexadecatrienyl acetates and the corresponding alcohols in a ratio of 40:60:4:6) was found to capture more males than traps baited with virgin females in field tests conducted in East Malaysia (Beevor, P. S., et al., J. Chem. Ecol., 12: 1-23 (1986)). Additional testing found that the synthetic pheromone was less effective in field tests conducted in West Malaysia, indicating possible strain differences that could affect lure efficacy (Matlick, B. K., Machete technology: What small cocoa farmers need! Review of pod borer control methods by small farmers in Indonesia, presented at the First International Workshop on Sustainable Cocoa Growing, 29 Mar. to 3 Apr., 1998, Smithsonian Tropical Research Institute, Panama, Republic of Panama). Zhang et al. (Zhang A., et al., Environmental Entomology, 37: 719-724 (2008)) found no regional differences in field tests conducted in Malaysia and Indonesia, but cited lack of commercial quantities and problems with quality control of synthetic pheromone components as issues that may have limited lure efficacy. Our own experience indicated that lures obtained from various sources (USDA collaborators, Alpha Scents, Inc., or Pest Control India) are highly variability in terms of efficacy, longevity, as well as pricing.

Therefore, we initiated research to identify kairomones that could be used as an alternative, reliable monitoring tool for CPB.

### SUMMARY OF THE INVENTION

Methods of attracting male Conopomorpha cramerella involving treating an object or area with a composition comprising a male Conopomorpha cramerella attracting effective amount of an extract of Litchi sinensis, and optionally a carrier; wherein the composition is in a trap.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Exemplary FIG. 1 shows a comparison of the number of male CPB captured in delta traps baited with various lychee-derived flavor products in a two-week field test as described herein. OLFE (Organic Lychee Flavor Extract), NLFC (Natural Lychee Flavor Concentrate), NLFE (Natural Flavor Lychee Emulsion), OFELL (Organic Fragrance Emulsion Lychee Love), OLFP (Organic Lychee Flavor Powder). Four replicates for each treatment were tested. Boxes presenting different letters are significantly different (Test Post Hoc LSD Fisher).

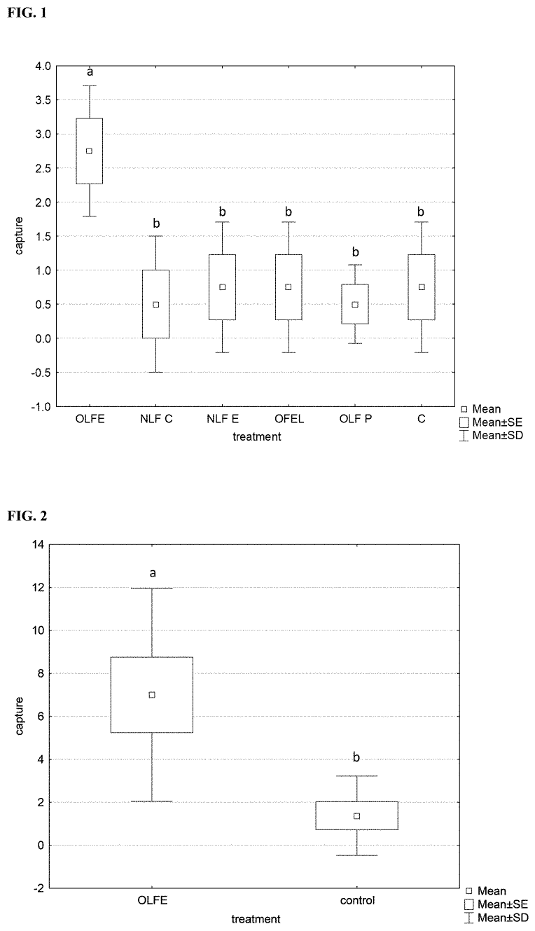

Exemplary FIG. 2 shows a comparison of the number of male CPB captured in delta traps baited with OLFE and unbaited control traps in a four-week field test as described herein. Eight replicates of both treatments were tested.

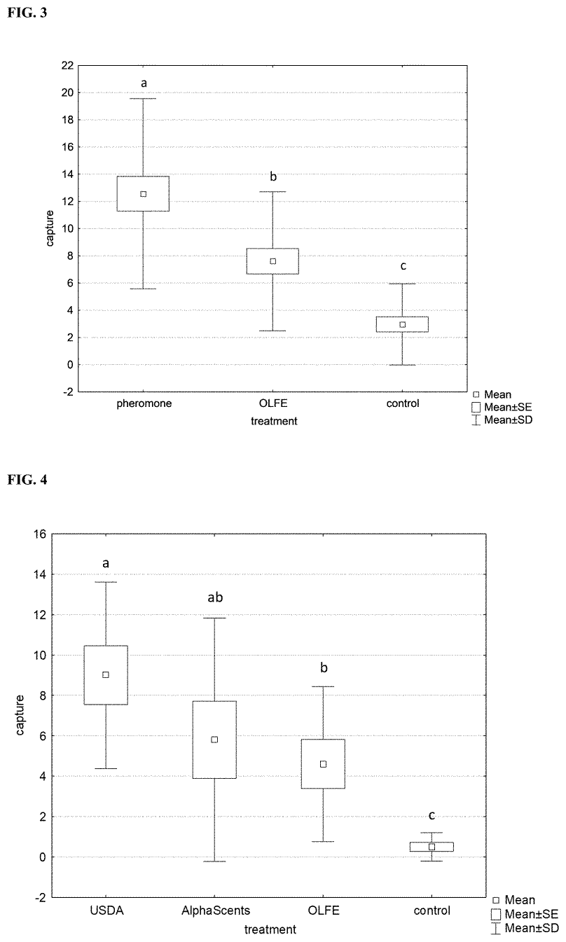

Exemplary FIG. 3 shows a comparison of the number of male CPB captured in delta traps baited with OFLE, pheromone lure (USDA), and unbaited control traps in a four-week field test as described herein. Thirty replicates per treatment were used in these trials. Boxes presenting different letters are significantly different (Test Post Hoc LSD Fisher).

Exemplary FIG. 4 shows a comparison of the number of male CPB captured in delta traps baited with OLFE, two sources of pheromone lures (USDA and Alpha Scents, Inc.), and unbaited control traps in a four-week field test as described herein. Ten replicates per treatment were used in this experiment. Boxes presenting different letters are significantly different (Test Post Hoc LSD Fisher).

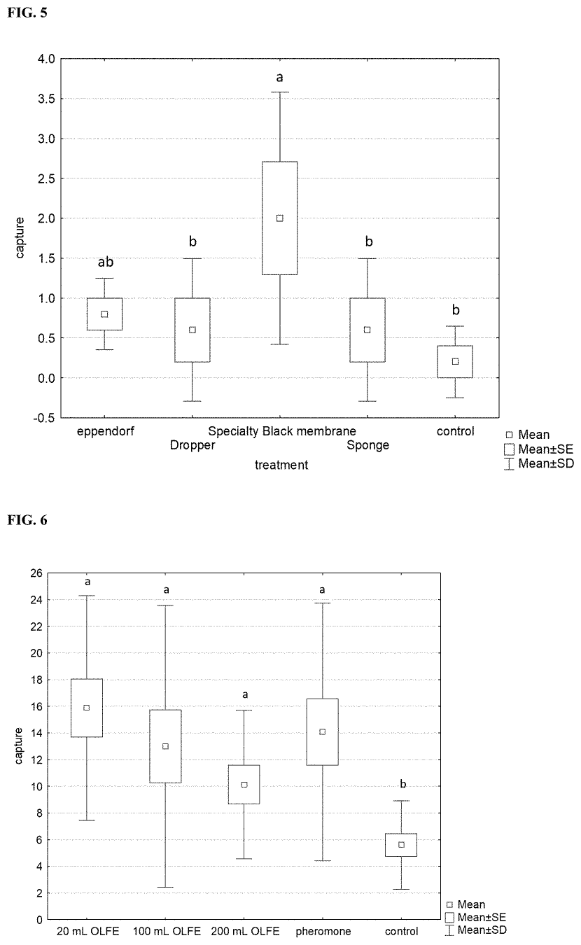

Exemplary FIG. 5 shows a comparison of the number of male CPB captured in delta traps baited with OLFE presented in various formulations and unbaited control traps in a four-week field test as described herein. Tested formulations included Eppendorf formulation containing 1 ml of OLFE, Plastic Dropper (LDPE) formulation containing 3 ml of OLFE, Specialty black membrane formulation containing 20 ml of OFLE, and Sponge formulation containing 100 ml of OLFE. Five replicates of each treatment were compared. Boxes presenting different letters are significantly different (Test Post Hoc LSD Fisher).

Exemplary FIG. 6 shows a comparison of the number of male CPB captured in delta traps baited with various loading doses of OLFE in the specialty black membrane formulation and unbaited control traps in a four-week field test as described herein. Fifteen replicates per treatment were tested. Boxes presenting different letters are significantly different (Test Post Hoc LSD Fisher).

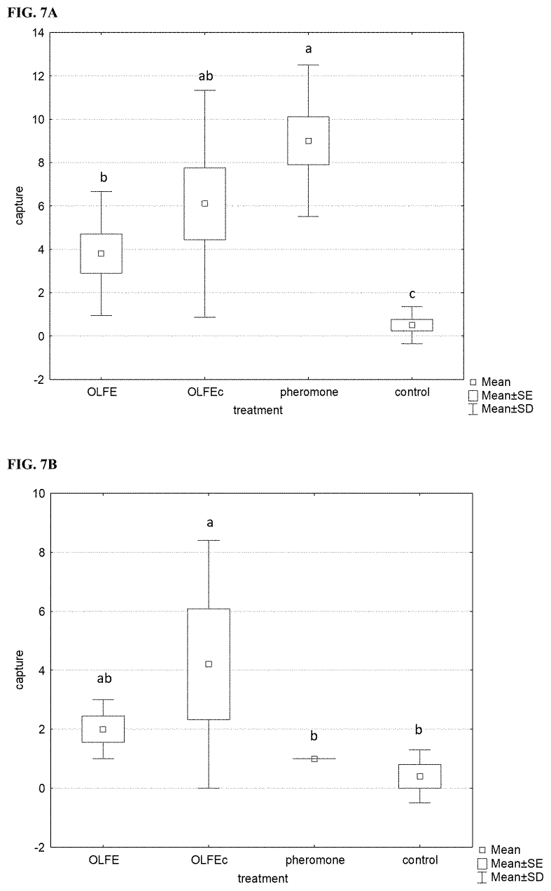

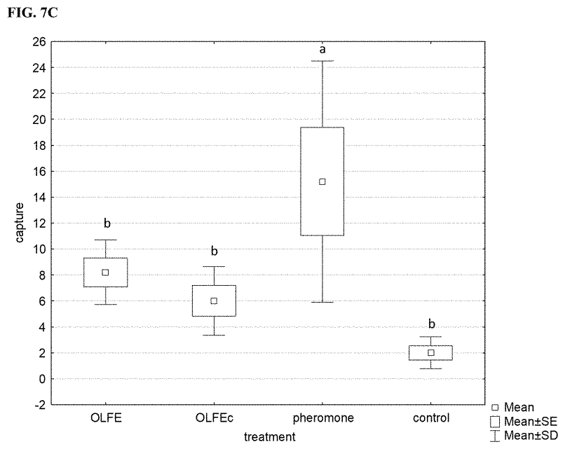

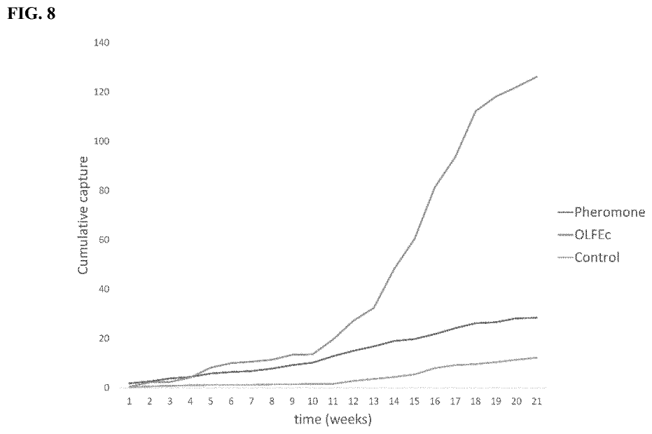

Exemplary FIG. 7A, FIG. 7B, and FIG. 7C show comparisons of the number of male CPB captured in delta traps baited with OLFE, concentrated OLFE (OLFEc), pheromone lures (USDA), and unbaited control traps as described herein. Parallel tests were conducted at the Insitu field site (FIG. 7A, 10 replicates), MCRC (Mars Cocoa Research Center) site (FIG. 7B, 5 replicates), and Pepuro site (FIG. 7C, 5 replicates). Kairomone treatments consisted of 20 ml samples in the specialty black membrane formulation. Boxes presenting different letters are significantly different (Test Post Hoc LSD Fisher).

Exemplary FIG. 8 shows a comparison of the cumulative captures of male CPB over a period of 21 weeks as described herein. Five replicates per treatment were used in this experiment. The experiment continued until no significant difference was recorded between treatments and control.

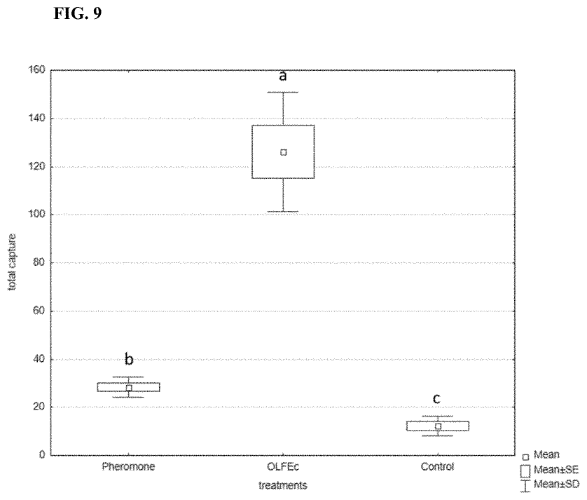

Exemplary FIG. 9 shows a comparison of the total captures of male CPB using pheromone lures, OLFEc lures and unbaited traps over a period of 21 weeks as described herein. Five replicates per treatment were used in this experiment. The experiment continued until no significant difference was recorded between treatments and control. Boxes presenting different letters are significantly different (Test Post Hoc LSD Fisher).

### DETAILED DESCRIPTION OF THE INVENTION

Disclosed herein are methods of attracting male Conopomorpha cramerella involving treating an object or area with a composition comprising a male Conopomorpha cramerella attracting effective amount of an extract of Litchi sinensis and optionally a carrier; wherein the composition is in a trap. Kairomones are natural volatile chemicals emitted by plants that typically function as olfactory attractants for sexually mature, mated female insects for location of appropriate host plants upon which to lay their eggs. It is important to emphasize that this kairomone (an extract of Litchi sinensis) was surprisingly attractive to males but not to females. Typically, kairomones only attract females looking for an appropriate host to lay eggs. In addition, as shown below, the kairomone attraction was just as strong as that of the pheromone lure, but costs significantly less.

The compositions described herein (useful, for example, in attracting male Conopomorpha cramerella), such as OLFE, may be applied with a carrier component or carrier (e.g., agronomically or physiologically or pharmaceutically acceptable carrier). The carrier component can be a liquid or a solid material. As is known in the art, the vehicle or carrier to be used refers to a substrate such as a membrane, hollow fiber, microcapsule, cigarette filter, gel, polymers, bag, vial, septa, or the like. All of these substrates have been used to release volatile chemicals in general and are well known in the art. Suitable carriers are well-known in the art and are selected in accordance with volatility of the chemical and the ultimate application of interest. Agronomically acceptable substances include aqueous solutions, oils, glycols, alcohols, ketones, esters, hydrocarbons, halogenated hydrocarbons, polyvinyl chloride; in addition, solid carriers such as clays, cellulosic, fibers, and rubber materials and synthetic polymers. Suitable carriers are to be selected in accordance with the best application for the release of the kairomone. Acceptable substances of particular interest are those that pose no threat to honeybees or non-target insects. Polyvinyl chloride is a carrier of interest, in addition, solid carriers such as clays, cellulosic and rubber materials and synthetic polymers. The carrier or carrier material as used herein is defined as not including the fruit of Litchi sinensis.

The amount of the composition for attracting male Conopomorpha cramerella used will be at least an effective amount (i.e., 1 mg or more). The term “effective amount,” as used herein, means the minimum amount of the composition needed to attract male Conopomorpha cramerella to a treated area or object or locus when compared to the same area or object or locus which is untreated. Of course, the precise amount needed will vary in accordance with the particular composition used; the type of area or object to be treated; the number of days of attractiveness needed; and the environment in which the area or object or locus is located. The precise amount of the composition can easily be determined by one skilled in the art given the teaching of this application. For example, one skilled in the art could follow the procedures utilized below; the composition would be statistically significant in comparison to a control (e.g., water). Generally, the concentrations of synthetic chemicals discussed herein on polypropylene flex tube or plastic bag would range from about 10 mg to about 250 mg (e.g., 10 to 250 mg), monitoring traps would generally use about 50 mg while attract and kill may use about 250 mg, and release rates could generally be about 0.05 to about 30 mg (e.g., 0.05 to 30 mg) per tube/bag per day.

The compositions described herein may or may not contain a control agent for male Conopomorpha cramerella, such as a biological control agent or an insecticide known in the art to kill Conopomorpha cramerella. Other compounds may be added to the composition provided they do not substantially interfere with the intended activity of the composition; whether or not a compound interferes with attractant activity can be determined, for example, by the procedures utilized below.

Other compounds (e.g., Conopomorpha cramerella attractants known in the art) may be added to the composition provided they do not substantially interfere with the intended activity and efficacy of the composition; whether or not a compound interferes with activity and/or efficacy can be determined, for example, by the procedures utilized below.

“Optional” or “optionally” means that the subsequently described event or circumstance may or may not occur, and that the description includes instances in which said event or circumstance occurs and instances where it does not. For example, the phrase “optionally comprising an insecticide” means that the composition may or may not contain an insecticide and that this description includes compositions that contain and do not contain an insecticide. Also, by example, the phrase “optionally adding an insecticide” means that the method may or may not involve adding an insecticide and that this description includes methods that involve and do not involve adding an insecticide.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments and characteristics described herein and/or incorporated herein. In addition, the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount. For example, about 1.0 g means 0.9 g to 1.1 g and all values within that range, whether specifically stated or not.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### Examples

Materials tested: Five lychee flavor products (Nature's Flavors Inc., Orange, Calif.) were tested in the field for kairomone activity: organic lychee flavor extract (OLFE) (ref NF-6096), organic lychee flavor powder (OUP) (ref NF-9641), organic fragrance emulsion lychee love (OFELL) (ref NF-Lylo), natural lychee flavor emulsion for high heat (NLFE) (NF-8070), and natural lychee flavor concentrate (NLFC) (NF-2420). Lychee flavor extract (OLFE) may be prepared by known methods of preparing plant (e.g., Sapindales order) extracts; the extracts are extracts of the plant and/or fruit. Pheromone lures (0.1 mg of pheromone blend of (E,Z,Z)- and (E,E,Z)-4,6,10-hexadecatrienyl acetates and the corresponding alcohols in a ratio of 40:60:4:6) in polyethylene vials (26×8×1.5 mm thick; Just Plastic, Norwich, United Kingdom) were provided by USDA-ARS, Beltsville, Md., and used as a positive control. The pheromone blend was prepared as described in Zhang et al. (2008). A second source of pheromone lure was provided by Alpha Scents Inc. (West Linn, Oreg.) using the same ratio as Vanhove et al. (Vanhove, W., et al., Journal of Applied Entomology, 139: 660-668 (2015)) but with a slight variation in their polyethylene vials (LDPE microcentrifuge vial, Thermo Fisher Scientific, Waltham, Mass.). The pheromone vials were hung above the sticky liners of the delta traps in the same way as with the ‘kairomone’ source.

Experimental sites: Field experiments were conducted from November 2016 to December 2019 in three locations differing by the presence of shading trees, by the cocoa clones/hybrid used, and by the management practices. Sites #1 and #2 were two private cocoa farms, locally named Insitu and Pepuro, located near Tarengge, East Luwu, Indonesia (−2.545376, 120.792307). Plantings at these sites were composed primarily of cocoa clones PBC123 and BR25 that were planted 3 m apart within a row, with 3 m spacing between rows, and irregularly shaded by durian and banana trees. The trees were not regularly pruned but were treated with unknown pesticide without artificial irrigation. Site #3 was located at the Mars Cocoa Research Center (MCRC) in Tarengge, East Luwu (−2.5574.5, 120.798752), and contained trees of the cocoa clone MO1. No pesticide was applied during our field experiments but the trees were irrigated.

Field experiments: Field trials were conducted using white plastic delta traps (20×24×11 cm) (ISCA Technologies Inc., Riverside, Calif.) hung on PVC poles at 1 m above the tree canopy. A white sticky liner was inserted into each trap to retain the captured insects. The samples were first tested in Eppendorf tubes with a lid pierced with a 1 mm hole before being hung in the delta trap using a wire. Each experiment lasted 4 weeks (unless specified otherwise), traps were checked weekly, and number and sex of moths captured was recorded. CPB individuals captured were sexed in the field based on the observation of their external genitalia, as previously described (Bradley, J. D., Bulletin of Entomology Research, 76: 41-51 (1986)). Undetermined specimens were brought back to the lab for further observation under an Amscope 3.5×-0.90× Track Stand Stereo Zoom binocular microscope (Amscope, Irvine, Calif.). Females have a characteristic ovipositor with hairy anal papillae, while males present a darker and wider caudal segment with the presence of a hair pencil.

Evaluation of lychee flavor products: A 2-week field experiment was conducted at site #1 to compare captures with OLFE, NLFC, NLFE, OFELL, OLFP, and an unbaited control trap. One mL of each sample was added to an Eppendorf tube perforated by a 1 mm diameter hole on the lid. When the sample was a powder, it was diluted into 1 mL of ethanol 70% before being added into the tube. The test followed a randomized complete block design with four replicate blocks arranged in a rectangular grid.

To confirm results observed in the initial test, a second field trial was conducted at site #1. This subsequent test only compared two treatments: the most attractive kairomone (OLFE) and an unbaited control trap. Test conditions were as described above; however, this experiment was run for 4 weeks and traps were deployed in eight replicate blocks.

Comparison of OLFE to pheromone lures: Two field experiments were conducted to compare the number of moths captured with OLFE to those captured with CPB pheromone and unbaited control traps. The first test, conducted at site #1, used pheromone lures provided by the USDA, deployed in 30 replicate blocks. This was followed by a second field experiment at site #1 which used lures from both USDA and Alpha Scents, Inc., and had ten replicates per treatment.

Formulation testing: A field trial was conducted at site #3 to test the effect of lure formulation on efficacy of OLFE. Four formulations were provided by Alpha Scents, Inc.: ‘Eppendorf formulation’, made from an Eppendorf tube (Thermo Fisher Scientific, Waltham, Mass.) with a 1 mm hole on the cap filled with 1 ml kairomone extract (identical to that used in previous field experiments); ‘dropper formulation’, made from the bulb portion of a disposable plastic 4 ml LDPE transfer pipette (Ø=12 mm×40 mm, 0.46 mm wall) (Thermo Fisher Scientific, Waltham, Mass.), filled with 3 ml extract and then heat sealed; ‘Specialty black membrane formulation’ (90×105 mm; 0.01 mm wall) (Thermo Fisher Scientific, Waltham, Mass.), containing a piece of corrugated cardboard (65×90 mm), filled with 20 ml of extract and sealed with a heating vacuum sealer; and a ‘sponge formulation’, made from a transparent LDPE bag (160×100 mm; 0.18 mm wall) (Thermo Fisher Scientific, Waltham, Mass.), containing a sponge (25×50×100 mm) filled with 100 ml of extract and sealed with a heating vacuum sealer. Unbaited controls were added and there were five replicates per treatment used in this trial.

Dose response: Another field test was conducted at site #1 to determine the effect of dose on efficacy of OLFE using the most effective formulation (the Specialty black membrane). Treatments consisted of OLFE at loading doses of 20, 100 and 200 (2×100) mL as well as USDA pheromone and an unbaited control. This experiment was conducted using fifteen replicate blocks.

Product modification: The OLFE product was concentrated by removing the ethanol solvent using a rotary evaporator Heidolph Hei-VAP (Heidolph, Elk Grove Village, Ill.) at 50 rpm and 60° C. for 60 min. The concentrated OLFE (OLFEc) was then tested in the field against the original OLFE, the pheromone lure (USDA), and an unbaited control. Field experiments were conducted at all three sites: site #1 (10 replicates), site #2 (5 replicates), and site #3 (5 replicates). For each experiment, kairomone lures consisted of 20 ml of OLFE or OLFEc, formulated in the Specialty black membrane.

Additive and synergetic effects: Two field experiments were conducted over a 4 week time period in sites #2 and #3 to test the potential additive or synergetic effect of OLFE and the pheromone lures. The 20 ml plastic membrane OLFE lures were deployed alone in the delta trap or in addition to the pheromone lures inside the same trap. Those two treatments were compared with the pheromone lure alone and to unbaited traps. Five replicates per treatment were used in site #2, while 10 replicates per treatment were used in site #3.

Longevity of the concentrated OLFE: A field experiment conducted in site #2 was set-up in June 2019 to assess the longevity of OLFEc attractiveness to CPB males compared to pheromone lures and unbaited traps. Five replicates per treatment were used in this experiment. At weekly intervals, the number of captures was recorded and the traps were rotated until no significant difference in captures was recorded between the treatments and the control. The lures were not replaced in this experiment and the experiment ended in December 2019.

Statistics: Analysis of Variance followed by Post Hoc Fisher LSD tests were performed to compare the number of male CPB captures per treatment in field experiments. When only two treatments were tested, Student t-tests were performed (Statistica 12 ®, Dell Inc., Tulsa, Okla.).

Results. Evaluation of lychee flavor products: At field site #1, with a low CPB population density, OLFE surprisingly captured significantly more males than the other four extracts and the unbaited control (F_{5,18}=3.60; p=0.01970). On average, OLFE captured 1.38±0.48 males/wk during the initial two-week trial compared to 0.38±0.48 males/wk with the controls (FIG. 1).

Assessment of OLFE efficacy as a monitoring tool (in comparison to unbaited control): Over the 4-week experiment, OLFE lures were significantly more attractive to male CPB than unbaited traps (t=3.0076; df=8; p=0.009408). On average, the OLFE lures captured 1.75±1.24 males/wk compared to 0.35±0.46 males/wk with the unbaited controls (FIG. 2).

Comparison to Pheromone lures. Pheromone lures from USDA: Both pheromone and OLFE lures attracted significantly more males than the unbaited traps (F_{2,86}=24.139; p=0.000001). Captures with the OLFE lures represented approximately half of the number of males captured by the USDA pheromone lures after the first week (2.23±2.14 vs 5.20±4.93 males/wk, respectively) with 0.86±0.99 males/wk with the unbaited control (F_{2,86}=14.472, p=0.0001); however, the difference between OLFE and pheromone lures surprisingly disappeared at week 2. Mean captures of male CPB at the end of the 4-week test surprisingly confirmed that OLFE is significantly more attractive than the control (1.9±1.38 vs 0.75±0.75 males/wk, respectively), and represented about 60% of the pheromone captures (3.14±1.74 males/wk) (F_{2,86}=24.139; p=0.000001) (FIG. 3).

Pheromone lures from Alpha Scents, Inc. and USDA: Pheromone lures from both suppliers and the OLFE lures were all significantly more attractive to CPB than the unbaited traps (F_{3,36}=6.7718; p=0.00097). The USDA pheromone lure captured the most, with an average of 2.25±1.16 males/wk. Pheromone lures from Alpha Scents, Inc. captured an average of 1.45±1.51 males/wk, which was surprisingly not significantly different than captures with the OLFE lure (1.15±0.96 males/wk) (FIG. 4).

Formulation testing: At the time this field experiment was conducted, CPB population density was very low; however, the differences in captures among formulations were sufficient to reveal a general trend (F_{4,20}=2.6000; p=0.06716). Highest male captures were surprisingly observed when OLFE was formulated with the Specialty black membrane, lowest captures with the dropper and sponge formulations, and intermediate captures with the Eppendorf formulation. The best delivery system, the black membrane formulation, captured an average of 0.25 males/wk, compared to 0.06 males/wk with the unbaited control trap (FIG. 5).

Kairomone dose response: In the OLFE dose response experiment using the Specialty black membrane formulation, there were significant differences in captures between the baited traps and the unbaited controls (F_{4,70}=3.7902; p=0.00757). However, surprisingly no significant differences were observed among the various loading volumes of OLFE; mean capture with the 20 ml dose was 4.0±2.1 males/wk, and increasing the volumetric dose did not result in an increase in CPB captures. In addition, there was surprisingly no significant difference in captures between the OLFE lures and the USDA pheromone lures (3.5±0.8 males/wk) (FIG. 6).

Product optimization: In field evaluations, the concentrated extract (OLFEc) was surprisingly competitive with the USDA pheromone lure in two of the three tests. At the Insitu farm (site #1, FIG. 7A), there was no difference in captures between OLFEc and pheromone lures (1.53±1.31 and 2.25±0.88 males/wk, respectively), but the pheromone caught more moths than OLFE (0.95±0.72 males/wk) (F_{3;36}=10.657; p=0.0004). All three lures captured more males than the control traps (0.13±0.21 males/wk). In the MCRC field test (site #3, FIG. 7B), captures with OLFEc (4.2±4.2) were greater than captures with the pheromone lure (1.0±0.0 males/wk), but the differences among treatments were not significant (F_{3,16}=2.8581; p=0.06978). Captures with the pheromone did not differ from captures with the unbaited control (0.25±0.0 males/wk). At the Pepuro farm (site #2, FIG. 7C), the number of captures with pheromone lures (3.8±2.3 males/wk) was significantly higher than all other treatments (F_{3,16}=6.0348; p=0.00598). Captures with OLFE (2.0±0.6 males/wk) and OLFEc (1.5±0.3 males/wk) were not significantly different.

Additive and synergetic effects: The combination of the pheromone and kairomone lures in a single trap did not have any additive or synergetic effects, but the opposite shut-down effect was observed in both field experiments (1.1±1.1, 1.1±0.9, and 0.8±0.4 male for pheromone lures, OLFE lures, and combination of both lures respectively, F_{3,16}=1.4547; p=0.2647; and 2.9±1.1, 2.7±1.3, and 1.5±0.8 males for pheromone lures, OLFE lures, and combination of both lures respectively, F_{3,35}=5.8692; p=0.00234). Because the population density was relatively low and the two field experiments showed a similar trend, we decided to treat them as a single experiment with fifteen replicates over a 4 week period.

When analyzed as a single test, the combined lures captured significantly fewer males (1.13±0.71 males) than the pheromone or the kairomone lures alone (2.28±1.36 and 2.12±1.37, respectively), and captured no more males than the unbaited traps (1.07±0.90) (F_{3,55}=4.7392; p=0.00519). No difference between kairomone and pheromone lures was recorded in this trial.

Longevity of the concentrated OLFE: The concentrated OLFE surprisingly captured significantly more males than the pheromone lures and the unbaited traps 5 weeks after the beginning of the experiment (F_{2,12}=4.363; p=0.038), and continued to capture significantly more males than unbaited traps until 21 weeks (almost 5 months) (FIG. 8).

In total, OLFEc surprisingly attracted an average of 126±25 males compared to 28±4 males for the pheromone lures, and 12±4 males for the unbaited trap over a period of 21 weeks (F_{2,12}=88.23; p<0.0001) (FIG. 9).

Discussion: Farmers in Sulawesi, Indonesia and other cocoa producing regions use prophylactic pesticide application for CPB control. In Malaysia, for instance, farmers routinely apply pesticide every two weeks. The frequency of these applications is very high and is not based on the pest population density. Development of an efficient low-cost CPB lure would facilitate population monitoring and contribute to more sustainable agricultural practices for cocoa production. The ability to assess population levels would allow cocoa producers to implement control strategies on an as-needed basis, reducing costs and minimizing detrimental effects to the environment. An efficient monitoring tool would also help in understanding male flight patterns, phenology, and spatial distribution, potentially improving integrated pest management in both conventional and organic orchards (e.g., targeting pesticide applications, applying pesticide only when threshold levels are reached, and implementing trap crop systems to reduce impact on cacao (Knight, A. L., and B. A. Croft, 1991, Modeling and prediction technology, pp. 301-312, IN: L. P. S. Van der Geest (ed.), Tortricid pests, Evenhuis H H, Elsevier, Amsterdam, The Netherlands; Niogret, J., et al., Florida Entomologist, 102 (2): 1-6 (2019)). The current CPB pheromone lures provide such a monitoring tool, but they are expensive, not readily available commercially, and are variable in their efficacy, both within a producing source and among different sources (JN, pers. observation).

Our results have shown that OLFE is surprisingly the most attractive product for detection of CPB males among the lychee extracts tested. In multiple field experiments using the Eppendorf vial formulation, OLFE consistently captured more males than unbaited control traps, and can be used as a CPB monitoring lure. Kairomone-based lures are often a concern because of the possible impact on non-target insect species that might be attracted, which usually does not occur with lures containing species-specitic sex pheromones (Leblanc, L., et al. Environmental Entomology, 38: 5: 1146-1461 (2009)). However, in our study, captures of non-target insects and female CPB were surprisingly negligible in OLFE-baited traps. OLFE surprisingly appears to exhibit a similar degree of species-specificity and potency as the synthetic pheromone blend for attraction of male CPB.

When initially compared to pheromone lures, OLFE in Eppendorf vial formulation captured only about half the number of CPB males as the USDA lure (which is not available commercially), but surprisingly captured an equivalent number of males as the lure developed by Alpha Scents, Inc. When the formulation was improved to the Specialty black membrane, OLFE was surprisingly competitive with the USDA pheromone lure as well, and this improvement in captures was independent of the loading dose of OLFE.

When the pheromone lure and the OLFE lures were combined, surprisingly no additive or synergetic effects were demonstrated. The number of males captured was actually lower when the lures were deployed together in a trap compared to the number of captures by the lures alone. Both pheromone and OLFE attract male CPB, while no females were attracted to the lure. Without being bound by theory, the significant decrease of the number of males captured in the traps with combined lures could indicate a repellency or a disruption effect.

Further improvement was achieved by concentrating OLFE using a rotary evaporator to obtain OLFEc. In two of three initial field experiments, captures with OLFEc were surprisingly equal to or better than captures with the USDA pheromone lure over a 4 week period, but the difference was only statistically significant in one test. In the subsequent longevity test, the 20 ml membrane formulation of OLFEc surprisingly remained attractive to male CPB for almost 5 months (21 weeks) compared to the unbaited traps, reaching an average capture of 6.0±1.2 males compared to 1.3±0.2 males for the pheromone lures. The OLFEc surprisingly was significantly attracting more CPB after 5 weeks. Without being bound by theory, the exponential increase in male captures with OLFEc after week 11 may be due to a peak of the CPB population density in the cocoa orchard; however, this increase was not detected with pheromone lures.

Currently, the OLFE extract sells for approximately $22 per L, corresponding to $0.02 of product per 1 mL lure (Epppendorf formulation) used in our early evaluations, or $0.40 per lure for the latter evaluations using 20 ml of extract in the black membrane formulation. This would provide a highly cost-effective alternative to pheromone lures which cost approximately $5.00 each (based on the lure obtained from Alpha Scents Inc.). Primary customers of a new CPB kairomone lure would include large corporations (e.g., Mars Inc. and other chocolate manufacturers for their extensive cocoa production and research plantings), Southeast Asian governments in cocoa producing countries (e.g., Indonesia, Malaysia, Papua New Guinea, Philippines), small private farm holders in these countries, and U.S. regulatory agencies that monitor for invasive pests.

Interestingly, our field experiments surprisingly indicated that only male CPB were attracted to OLFE, a putative host plant-derived product. However, the physiological state of the attracted males has not yet been investigated; it is not known if responsive males were sexually immature or mature, virgin or mated. Little is known about the mating process in CPB, and in general about how mating affects behavioral response to olfactory cues in male insects (Beyaert, I., and M. Hilker, Biological Reviews, 89: 68-81 (2014)).

All of the references cited herein, including U.S. patents and U.S. patent application Publications, are incorporated by reference in their entirety. Also incorporated by reference in their entirety are the following references: Barrozo, R. B., et al., J. Exp. Biol., 213, 2933-2939. (2010); Barrozo, R. B., et al., Eur. J. Neurosci., 33: 1841-1850 (2011); Beyaert & Hilker 2014; Dickens, J. C., et al., Chemoecology, 4: 175-177 (1993); Dickens, J. C., et al., Chemoecology, 4: 175-177 (1993); Bruce, T. J. A., et al., Trends in Plant Science, 10: 269-274 (2005); Cha, D. H., et al., Plos One, 6(2): e17033 (2011); Kendra, P. E., et al., PloS One, 9(7): e102086 (2014); Kendra, P. E., et al., Journal of Pest Science, 89: 427-438 (2016); Kromann, S. H., et al., Proceedings of the Royal Society B, 282: 20141884 (2015); Kutinkova, H., et al., J. Plant Prot. Res., 45: 49-52 (2005); Landolt, P. J., and T. W. Phillips, Annual Review of Entomology, 42: 371-391 (1997); Landolt, P. J., et al., Journal of Chemical Ecology, 33: 2236-2244 (2007); Beyaert & Hilker 2014; Dickens, J. C., et al., Chemoecology, 4: 175-177 (1993); Loeb, G. M., et al., Environmental Entomology, 40: 1511-1522 (2011); Reddy, G. V. P., and A. Guerrero, Trends in Plant Science, 9: 253-261 (2004); Schmidt-Büsser, D., et al., Journal of Comparative Physiology A, 195: 853-864 (2009); Schoonhoven, L. M., et al., Insect Plant Biology, Oxford University Press, 2005; Thwaite, W. G., et al., General & Applied Entomology, 33: 55-60 (2004) Torto, B., et al., Apidology, 36: 523-532 (2005); Torto, B., et al., Apidology, 38: 380-389 (2007a); Torto, B., et al., Proceedings of the National Academy of Sciences, 104(20): 8374-8378 (2007b); Varela, N., et al., Entomologia Experimentalis et Applicata, 141: 114-122 (2011); von Arx, M., et al., Journal of Chemical Ecology, 38: 222-225 (2012); Vos, J. G. M., et al., Discovery learning about cacao: an inspirational guide for training facilitators, 2003, CABI Bioscience, Surrey, United Kingdom.

Thus, in view of the above, there is described (in part) the following:

A method of attracting male Conopomorpha cramerella, said method comprising (consisting essentially of or consisting of) treating an object or area with a composition comprising (consisting essentially of or consisting of) a male Conopomorpha cramerella attracting effective amount of an extract of Litchi sinensis, and optionally a carrier (which does not include Litchi sinensis (whole or in pieces)); wherein said composition is in a trap (which does not include Litchi sinensis (whole or in pieces)). The above method, wherein said composition further comprises a Conopomorpha cramerella insecticide. The above method, wherein said composition further comprises a Conopomorpha cramerella biological control agent. The above method, wherein said composition further comprises a Conopomorpha cramerella insecticide and a Conopomorpha cramerella biological control agent.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein).

The invention illustratively disclosed herein suitably may be practiced in the absence of any element (e.g., method (or process) steps or composition components) which is not specifically disclosed herein. Thus, the specification includes disclosure by silence (“Negative Limitations In Patent Claims,” AIPLA Quarterly Journal, Tom Brody, 41(1): 46-47 (2013): “ . . . Written support for a negative limitation may also be argued through the absence of the excluded element in the specification, known as disclosure by silence . . . . Silence in the specification may be used to establish written description support for a negative limitation. As an example, in Ex parte Lin [No. 2009-0486, at 2, 6 (B.P.A.I. May 7, 2009)] the negative limitation was added by amendment . . . . In other words, the inventor argued an example that passively complied with the requirements of the negative limitation . . . was sufficient to provide support . . . . This case shows that written description support for a negative limitation can be found by one or more disclosures of an embodiment that obeys what is required by the negative limitation . . . .”

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

We claim:

1. A method of attracting male Conopomorpha cramerella, said method comprising treating an object or area with a composition comprising a male Conopomorpha cramerella attracting effective amount of an extract of Litchi sinensis, and optionally a carrier; wherein said composition is in a trap.

2. The method according to claim 1, wherein said composition further comprises a Conopomorpha cramerella insecticide.

3. The method according to claim 1, wherein said composition further comprises a Conopomorpha cramerella biological control agent.

4. The method according to claim 1, wherein said composition further comprises a Conopomorpha cramerella insecticide and a Conopomorpha cramerella biological control agent.
